(19) United States
(12) Patent Application Publication
(10) Pub. No.: US 2010/0140958 A1
(43) Pub. Date: Jun. 10, 2010

(54) Method for powering devices from intraluminal pressure changes

(75) Inventors: Roderick A. Hyde, Redmond, WA (US); Muriel Y. Ishikawa, Livermore, CA (US); Eric C. Leuthardt, St. Louis, MO (US); Michael A. Smith, Phoenix, AZ (US); Lowell L. Wood, JR., Bellevue, WA (US); Victoria Y.H. Wood, Livermore, CA (US)

Correspondence Address: IV - SUITER SWANTZ PC LLO, 14301 FNB PARKWAY , SUITE 220, OMAHA, NE, 68154, US

(73) Assignee: Searete LLC, a limited liability corporation of the state of Delaware

(21) Appl. No.: 12/386,054

(22) Filed: Apr. 13, 2009

Related U.S. Application Data
(63) Continuation-in-part of application No. 12/315,631, filed on Dec. 4, 2008.
Application No. 12/315,631 is a continuation-in-part of application No. 12/315,616, filed on Dec. 4, 2008.

(51) Int. Cl. F03G 7/04

(52) U.S. Cl. 290/1 R

(57) ABSTRACT

A method for extracting power from intraluminal pressure changes may comprise one or more of the following steps: (a) receiving an intraluminal pressure change; (b) converting an intraluminal pressure change into energy with an intraluminal generator; and (c) providing the energy to a power utilization device.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 12/315,631, titled “Method for Generation of Power from Intraluminal Pressure Changes”, naming Roderick A. Hyde, Muriel Y. Ishikawa, Eric C. Leuthardt, Michael A. Smith, Lowell L. Wood, Jr. and Victoria Y. H. Wood as inventors, filed Dec. 4, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/315,616, titled “Method for Generation of Power from Intraluminal Pressure Changes”, naming Roderick A. Hyde, Muriel Y. Ishikawa, Eric C. Leuthardt, Michael A. Smith, Lowell L. Wood, Jr. and Victoria Y. H. Wood as inventors, filed Dec. 4, 2008, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week1/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND

Small scale generators for generating energy at levels suitable for powering devices which are in vivo or ex vivo to a human or animal are described. Such generators may be implanted in luminal structures so as to extract power from intraluminal pressure changes.

### BRIEF DESCRIPTION OF THE FIGURES

FIG. 1 shows a high-level block diagram of an intraluminal power generation system.

FIG. 2 shows a high-level block diagram of an intraluminal power generation system.

FIG. 3 is a high-level logic flowchart of a process.

FIG. 4 is a high-level logic flowchart of a process.

FIG. 5 is a high-level logic flowchart of a process.

FIG. 6 is a high-level logic flowchart of a process.

FIG. 7 is a high-level logic flowchart of a process.

FIG. 8 is a high-level logic flowchart of a process.

FIG. 9 is a high-level logic flowchart of a process.

FIG. 10 is a high-level logic flowchart of a process.

FIG. 11 is a high-level logic flowchart of a process.

FIG. 12 is a high-level logic flowchart of a process.

FIG. 13 is a high-level logic flowchart of a process.

FIG. 14 is a high-level logic flowchart of a process.

FIG. 15 is a high-level logic flowchart of a process.

FIG. 16 is a high-level logic flowchart of a process.

FIG. 17 is a high-level logic flowchart of a process.

FIG. 18 is a high-level logic flowchart of a process.

FIG. 19 is a high-level logic flowchart of a process.

FIG. 20 is a high-level logic flowchart of a process.

FIG. 21 is a high-level logic flowchart of a process.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

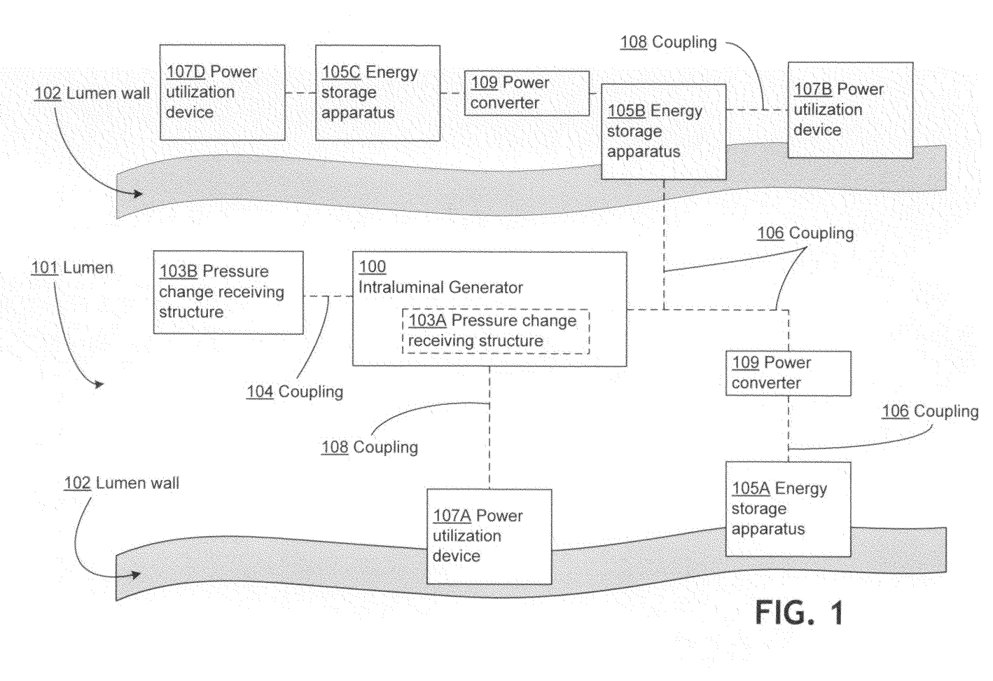

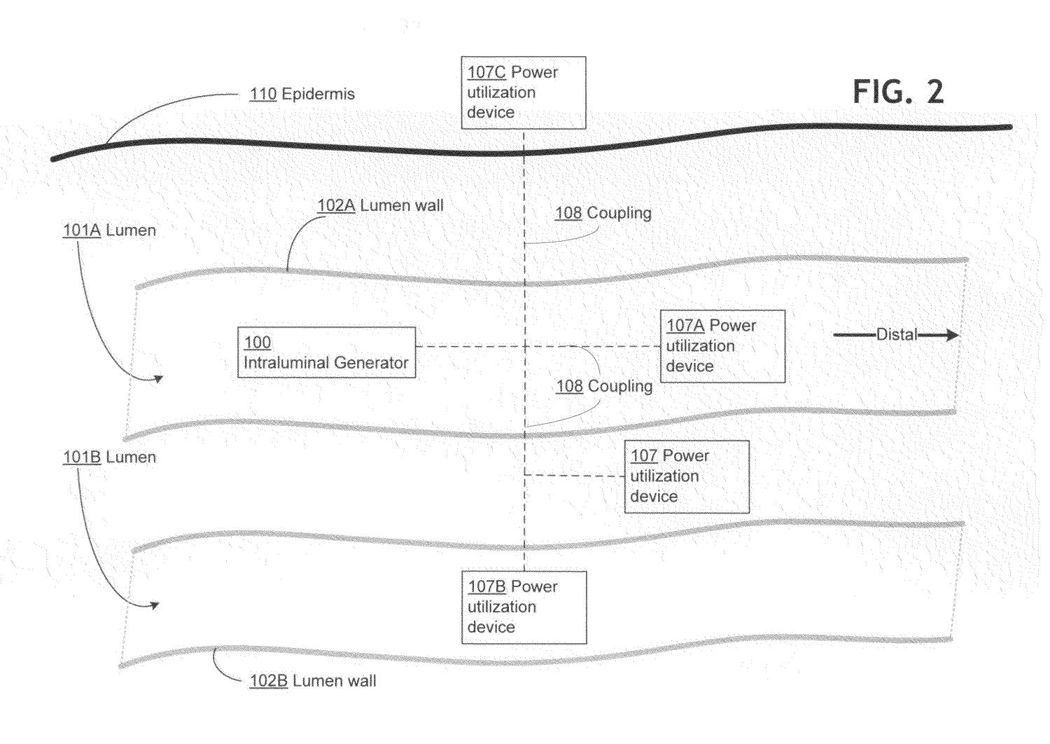

FIGS. 1 and 2 illustrate example environments in which one or more technologies may be implemented. An intraluminal power generation system may comprise intraluminal generator 100 configured for disposal/implantation within an anatomical lumen 101 of a user (not shown) defined by a lumen wall 102. The generator may be configured to convert a varying intraluminal pressure into energy (e.g. electrical energy, mechanical/elastic energy, chemical energy, thermal energy).

The intraluminal generator 100 may include an integrated pressure change receiving structure 103A configured to receive a pressure change associated with a fluid pressure within the lumen 101. Alternately, a pressure change receiving structure 103B may be operably coupled to the intraluminal generator 100 via a coupling 104 to transfer a received pressure from the pressure change receiving structure 103B to the intraluminal generator 100 in a form which the intraluminal generator 100 may convert to energy.

The intraluminal power generation system may comprise an energy storage apparatus 105 for storage of energy generated by the intraluminal generator 100. The energy storage apparatus 105 may be operably coupled to the intraluminal generator 100 by a coupling 106.

The intraluminal power generation system may comprise a power utilization device 107 which may use energy generated by the intraluminal generator 100 and/or stored in the energy storage apparatus 105 to carry out a desired function. The power utilization device 107 may be operably coupled to the intraluminal generator 100 or an energy storage apparatus 105 by a coupling 108.

FIG. 2 illustrates various spatial configurations of one or more components of an intraluminal power generation system. An intraluminal generator 100 disposed within in a first lumen 101A may be operably coupled to power utilization device 107A disposed in the first lumen 101A (e.g. in a distal relationship to the power utilization device 107A). An intraluminal generator 100 disposed within in a first lumen 101A may be operably coupled to power utilization device 107B disposed in a second lumen 101B. An intraluminal generator 100 disposed within in a first lumen 101A may be operably coupled to an ex vivo power utilization device 107C disposed outside an epidermal layer 110. An intraluminal generator 100 disposed within in a first lumen 101A may be operably coupled to power utilization device 107D disposed outside the first lumen 101A.

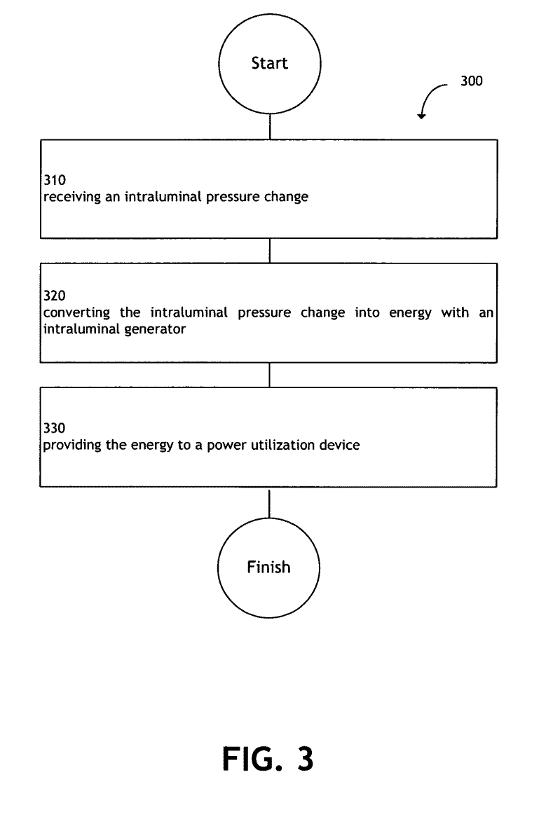

FIG. 3 illustrates an operational flow 300 representing example operations related to generating power from changes in intraluminal pressure. In FIG. 3 and in following figures that include various examples of operational flows, discussion and explanation may be provided with respect to the above-described examples of FIGS. 1 and 2, and/or with respect to other examples and contexts. However, it should be understood that the operational flows may be executed in a number of other environments and contexts, and/or in modified versions of FIGS. 1 and 2. Also, although the various operational flows are presented in the sequence(s) illustrated, it should be understood that the various operations may be performed in other orders than those which are illustrated, or may be performed concurrently. Also, although the various operational flows may include “start” and/or “finish” operations, it should be understood that such operations are merely presented to describe the particular illustrated examples and should not be read to limit the order in which the operations are performed.

After a start operation, the operational flow 300 moves to an operation 310. Operation 310 depicts receiving an intraluminal pressure change. For example, as shown in FIG. 1, a change in pressure within the lumen 101 may be received by a pressure change receiving structure 103. The pressure change receiving structure 103 may receive a change in pressure through exposure of a surface of the pressure change receiving structure 103 to the luminal environment such that a change in the intraluminal pressure may exert a force on the pressure change receiving structure 103 thereby resulting in a deformation of the pressure change receiving structure 103.

Operation 320 depicts converting an intraluminal pressure change into energy with an intraluminal generator. For example, as shown in FIG. 1, a change in pressure within the lumen 101 may be received by a pressure change receiving structure 103. The pressure change receiving structure 103 may receive a change in pressure through exposure of a surface of the pressure change receiving structure 103 to the luminal environment such that a change in the intraluminal pressure may exert a force on the pressure change receiving structure 103 thereby resulting in a deformation of the pressure change receiving structure 103. The intraluminal pressure change may include, but is not limited to, a change in the pressure of an intraluminal fluid (e.g. blood pressure) or gas (e.g. respiratory pressure). The pressure change receiving structure 103 may include, but is not limited to, a cantilevered beam structure, a trampoline structure, a camshaft structure, a lever structure, and the like. The change in pressure may induce a movement and/or deformation of the pressure change receiving structure 103 which may be translated either directly (e.g. the intraluminal generator 100 comprises the pressure change receiving structure 103A) or indirectly (e.g. the pressure change receiving structure 103B is operably coupled to a generator) into energy either through the motion of the pressure change receiving structure 103 and/or the electrical properties of the materials comprising the pressure change receiving structure 103. The intraluminal generator 100 may include but is not limited to, piezoelectric generator, a microelectromechanical system (MEMS) generator, mechanical generator, a ferromagnetic generator, a fluid displacement generator, and the like.

Operation 330 depicts providing the energy to a power utilization device. For example, as shown in FIG. 1, energy generated by the intraluminal generator 100 in response to the movement and/or deformation of the pressure change receiving structure 103 may be provided to one or more devices (e.g. a power utilization device 107) which may require one or more types of energy (e.g. electromagnetic, kinetic) to perform a function.

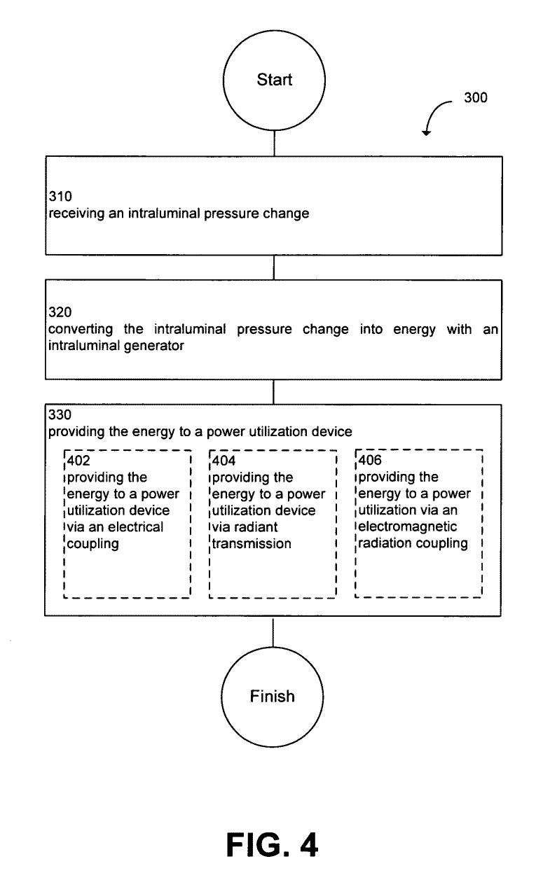

FIG. 4 illustrates alternative embodiments of the example operational flow 300 of FIG. 3. FIG. 4 illustrates example embodiments where the providing operation 330 may include at least one additional operation. Additional operations may include an operation 402, an operation 404 and/or an operation 406.

Operation 402 depicts providing the energy to a power utilization device via an electrical coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an electrical coupling 106 (e.g. one or more wires).

Operation 404 depicts providing the energy to a power utilization device via radiant transmission. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by a coupling 106. One or more of the intraluminal generator 100 and the power utilization device 107 may comprise one or more of an radiant transmitter (e.g. a light-emitting diode, a radio transmitter, an acoustical transmitter) and an radiant receiver (e.g. a photo detector, a radio receiver, and the like) whereby energy may be transmitted via radiant signals transceived between the intraluminal generator 100 and the power utilization device 107.

Operation 406 depicts providing the energy to a power utilization device via an electromagnetic radiation coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by a electromagnetic radiation (EMR) coupling 106. One or more of the intraluminal generator 100 and the power utilization device 107 may comprise one or more of an EMR transmitter (e.g. a radio transmitter) and an EMR receiver (e.g. a radio receiver) whereby energy may be transmitted via EMR signals transceived between the intraluminal generator 100 and the power utilization device 107.

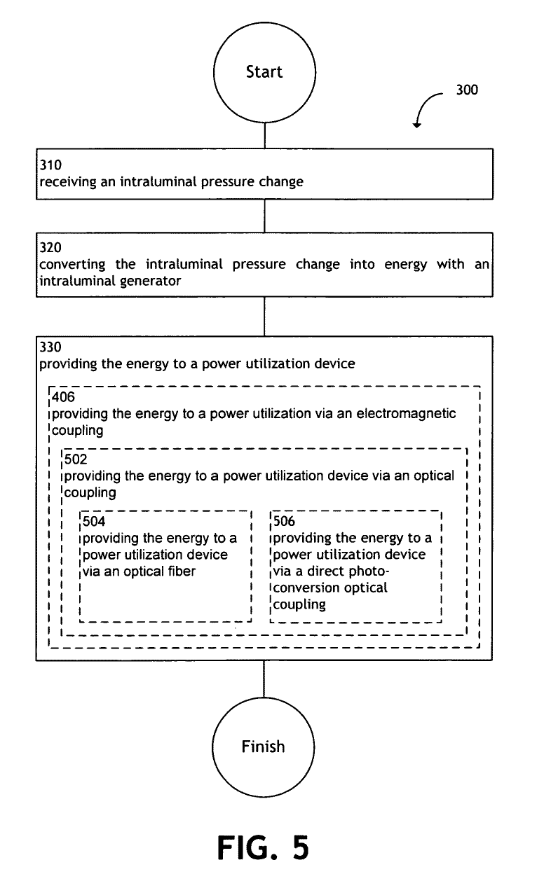

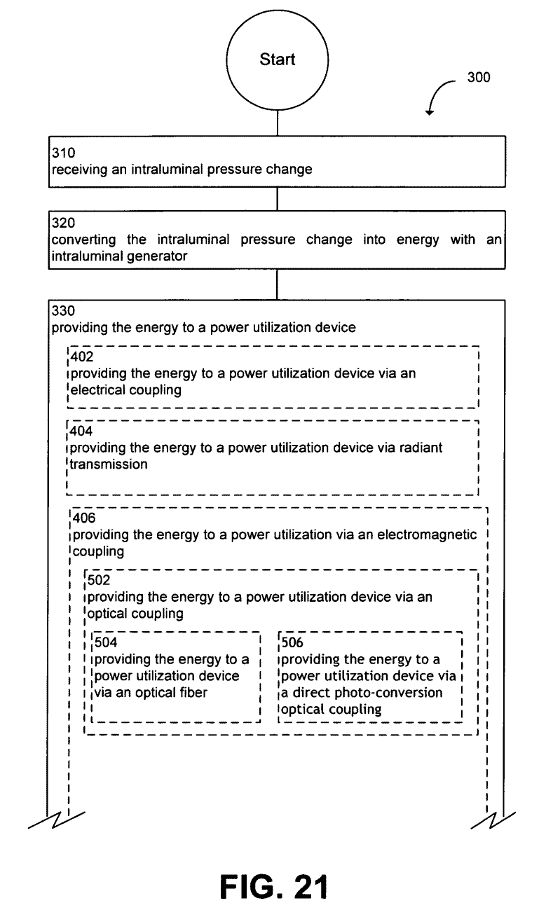

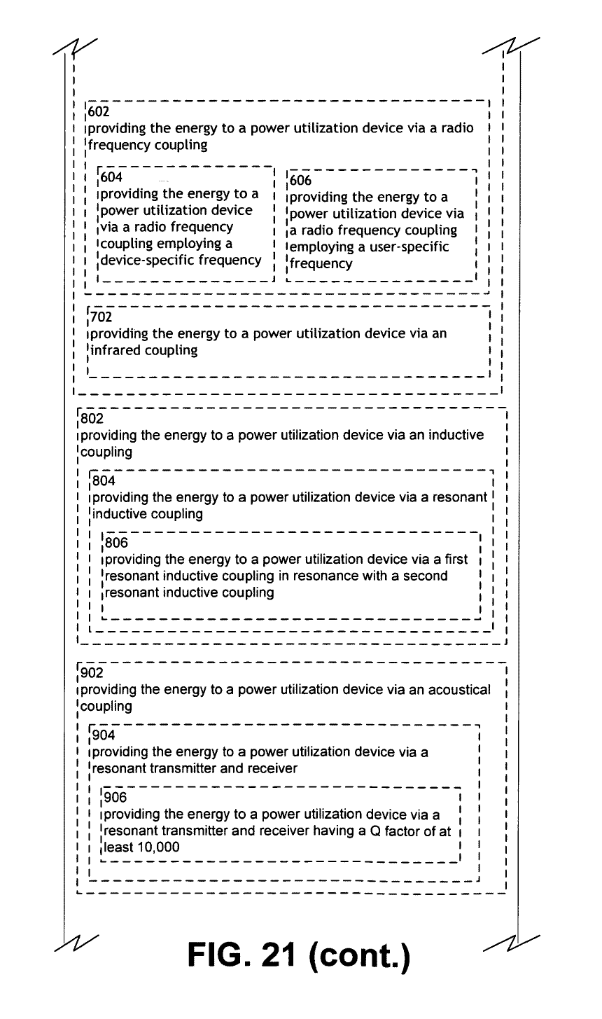

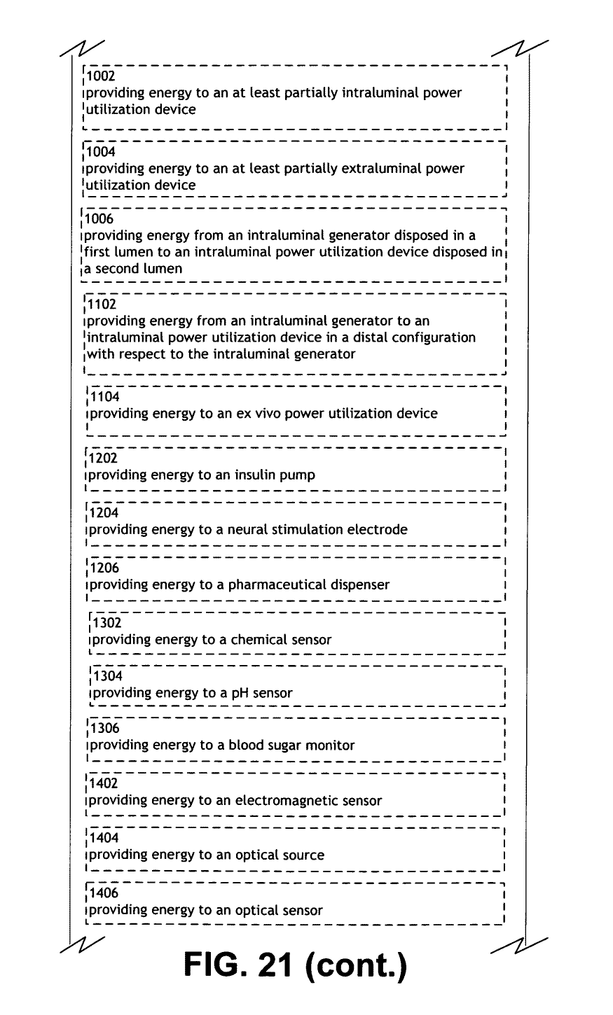

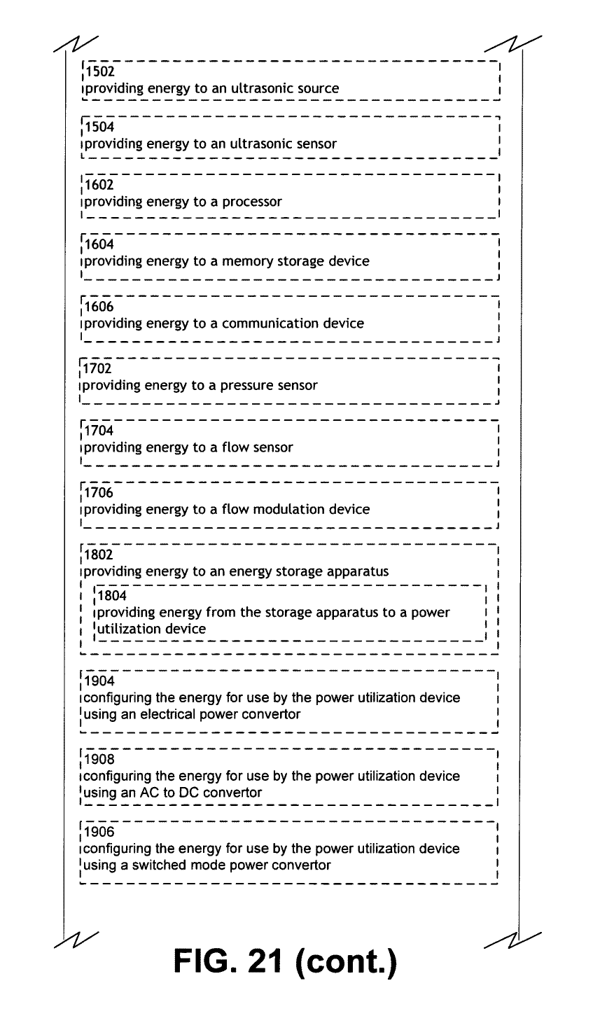

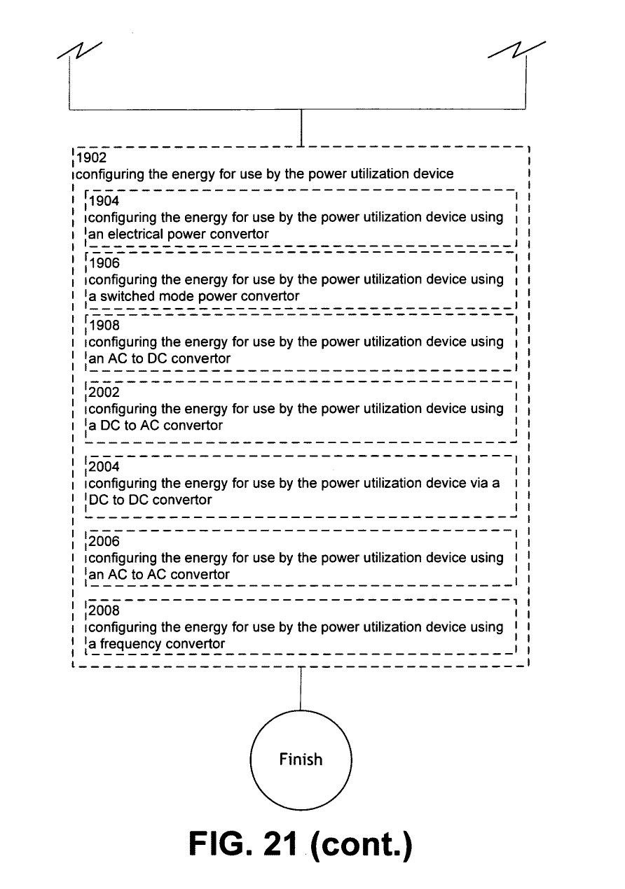

FIGS. 5 and 21 illustrate alternative embodiments of the example operational flow 300 of FIG. 4. FIGS. 5 and 21 illustrate example embodiments where the providing operation 406 may include at least one additional operation. Additional operations may include an operation 502, an operation 504, and/or an operation 506.

Operation 502 depicts providing the energy to a power utilization device via an optical coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an optical coupling 106. One or more of the intraluminal generator 100 and the power utilization device 107 may comprise one or more of an optical transmitter (e.g. a light-emitting diode, a laser diode and the like) and an optical receiver (e.g. a photo diode, a photo detector and the like) whereby energy may be transmitted via EMR signals in the visible-light spectrum are transceived between the intraluminal generator 100 and the power utilization device 107.

Operation 504 depicts providing the energy to a power utilization device via an optical fiber. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an optical fiber coupling 106. One or more of the intraluminal generator 100 and the power utilization device 107 may comprise one or more of an optical transmitter (e.g. a light-emitting diode, a laser diode and the like) and an optical receiver (e.g. a photo diode, a photo detector and the like) whereby energy may be transmitted via optical signals transceived between the intraluminal generator 100 and the power utilization device 107 via the optical fiber coupling 106.

Operation 506 depicts providing the energy to a power utilization device via a direct photo-conversion optical coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an optical coupling 106. One or more of the intraluminal generator 100 and the power utilization device 107 may comprise one or more of an optical transmitter (e.g. a light-emitting diode, a laser diode and the like) and an optical receiver (e.g. a photo diode, a photo detector and the like) whereby energy may be transmitted via optical signals transceived between the intraluminal generator 100 and the power utilization device 107.

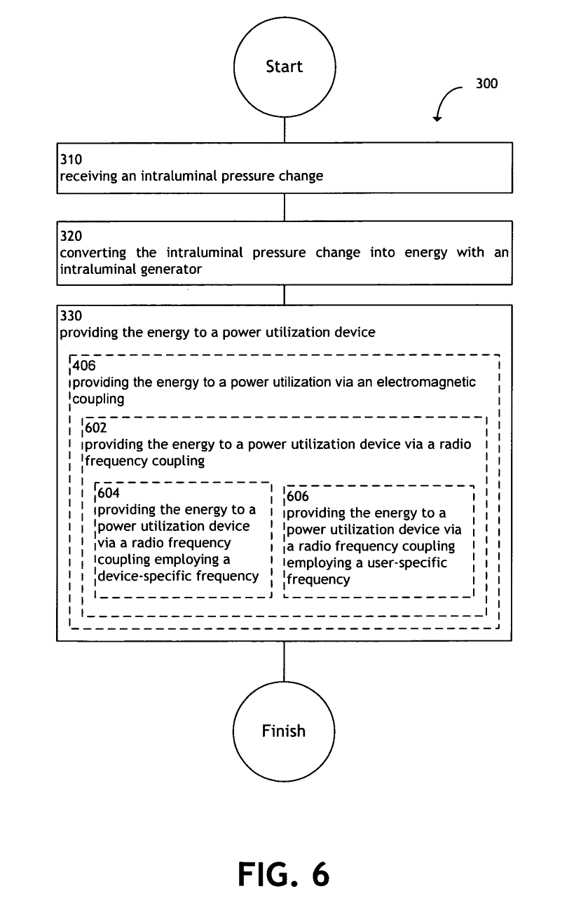

FIGS. 6 and 21 illustrate alternative embodiments of the example operational flow 300 of FIG. 4. FIGS. 6 and 21 illustrate example embodiments where the providing operation 406 may include at least one additional operation. Additional operations may include an operation 602, an operation 604 and/or an operation 606.

Operation 602 depicts providing the energy to a power utilization device via a radio frequency coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an electromagnetic radiation (EMR) coupling 106. One or more of the intraluminal generator 100 and the power utilization device 107 may comprise one or more of an EMR transmitter and an EMR receiver whereby energy may be transmitted via EMR signals in the radio-frequency spectrum transceived between the intraluminal generator 100 and the power utilization device 107.

Operation 604 depicts providing the energy to a power utilization device via a radio frequency coupling employing a device-specific frequency. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an electromagnetic radiation (EMR) coupling 106. One or more of the intraluminal generator 100 and the power utilization device 107 may comprise one or more of an EMR transmitter and an EMR receiver whereby energy may be transmitted via EMR signals in the radio-frequency spectrum transceived between the intraluminal generator 100 and the power utilization device 107 at a frequency associated with the power utilization device 107 so as to avoid interference with a second power utilization device (not shown).

Operation 606 depicts providing the energy to a power utilization device via a radio frequency coupling employing a user-specific frequency. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an electromagnetic radiation (EMR) coupling 106. One or more of the intraluminal generator 100 and the power utilization device 107 may comprise one or more of an EMR transmitter and an EMR receiver whereby energy may be transmitted via EMR signals in the radio-frequency spectrum transceived between the intraluminal generator 100 and the power utilization device 107 at a frequency associated with the power utilization device 107 so as to avoid interference with a power utilization device implanted in a user (not shown) distinct from the subject power utilization device 107.

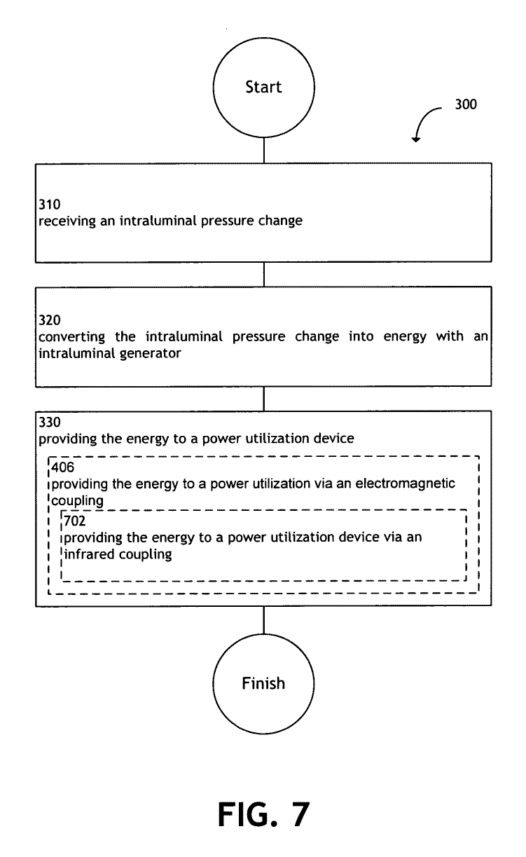

FIGS. 7 and 21 illustrate alternative embodiments of the example operational flow 300 of FIG. 4. FIGS. 7 and 21 illustrate example embodiments where the providing operation 406 may include at least one additional operation. Additional operations may include an operation 702.

Operation 702 depicts providing the energy to a power utilization device via an infrared coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an electromagnetic radiation (EMR) coupling 106. One or more of the intraluminal generator 100 and the power utilization device 107 may comprise one or more of an EMR transmitter and an EMR receiver whereby energy may be transmitted via EMR signals in the infrared-frequency spectrum transceived between the intraluminal generator 100 and the power utilization device 107.

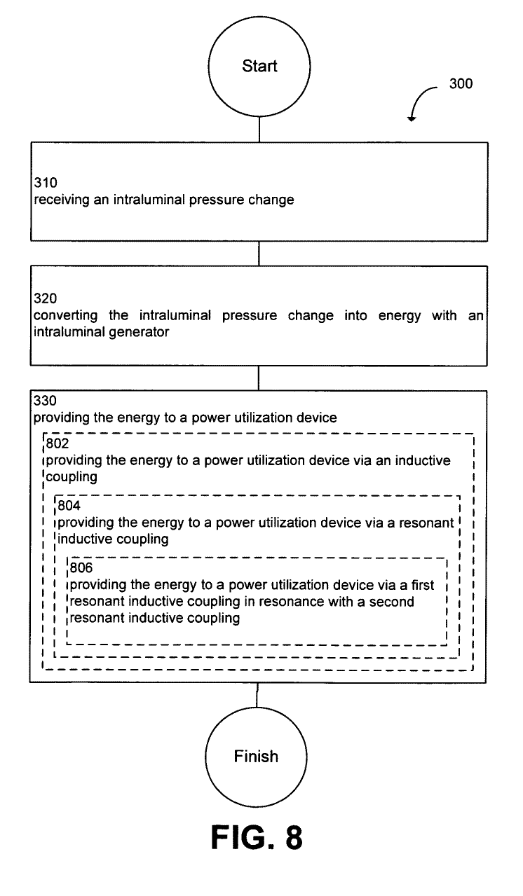

FIGS. 8 and 21 illustrate alternative embodiments of the example operational flow 300 of FIG. 7. FIGS. 8 and 21 illustrate example embodiments where the providing operation 704 may include at least one additional operation. Additional operations may include an operation 802 and/or an operation 804.

Operation 802 depicts providing the energy to a power utilization device via an inductive coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an inductive coupling 106. The intraluminal generator 100 may include circuitry (e.g. a solenoid) configured to generate a magnetic field. The power utilization device 107 may include circuitry configured to generate an electrical current when disposed in a location proximate to the magnetic field.

Operation 804 depicts providing the energy to a power utilization device via a resonant inductive coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by a resonant inductive coupling 106. The intraluminal generator 100 and the power utilization device 107 may include one or more waveguides configured to transceive evanescent electromagnetic signals. The waveguides may be configured such that a receiving waveguide is in resonance with a transmitting waveguide so as to provide evanescent wave coupling between the waveguides. Upon reception, the evanescent waves may be rectified into DC power for use in the power utilization device 107.

Operation 806 depicts providing the energy to a power utilization device via a first resonant inductive coupling in resonance with a second resonant inductive coupling. For example, as shown in FIG. 1, a first intraluminal generator 100 and first power utilization device 107 operably coupled by a first resonant inductive coupling 106 (as described above with respect to operation 802) may be at least partially co-located with a second intraluminal generator 100 and second power utilization device 107 operably coupled by a second resonant inductive coupling 106 within one or more anatomical structures. In order to avoid interference between the first resonant inductive coupling 106 and the second inductive coupling 106, the waveguides associated with the first resonant inductive coupling 106 and the waveguides associated with the second inductive coupling 106 may be configured so as to be in mutual resonance.

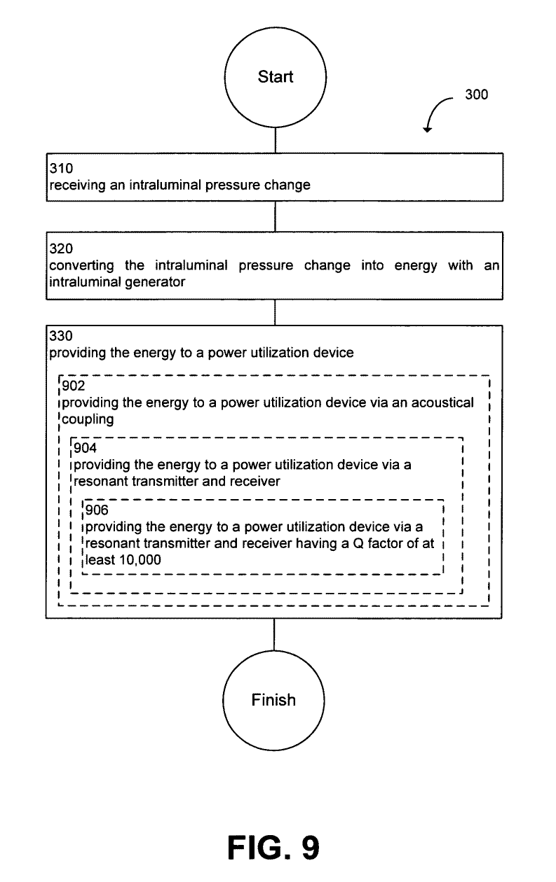

FIGS. 9 and 21 illustrate alternative embodiments of the example operational flow 300 of FIG. 5. FIGS. 9 and 21 illustrate example embodiments where the providing operation 502 may include at least one additional operation. Additional operations may include an operation 902, an operation 904 and/or an operation 906.

Operation 902 depicts providing the energy to a power utilization device via an acoustical coupling. For example, as shown in FIG. 1, energy generated by the intraluminal generator 100 in response to the movement and/or deformation of the pressure change receiving structure 103 may be transmitted to a power utilization device 107 operably coupled to the intraluminal generator 100 by an acoustical coupling 106. One or more of the intraluminal generator 100 and the power utilization device 107 may comprise one or more of an acoustical transmitter (e.g. an acoustic transducer and the like) and an acoustical receiver (e.g. a hydrophone) whereby energy may be conveyed via acoustical signals transceived between the intraluminal generator 100 and the power utilization device 107.

Operation 904 depicts providing the energy to a power utilization device via a resonant transmitter and receiver. For example, as shown in FIG. 1, and described above with respect to operation 902, one or more of the intraluminal generator 100 and the power utilization device 107 may comprise one or more of an acoustical transmitter (e.g. an acoustic transducer and the like) and an acoustical receiver (e.g. a hydrophone) whereby energy may be conveyed via acoustical signals transceived between the intraluminal generator 100 and the power utilization device 107. The one or more acoustical transmitters and acoustical receivers may be in resonance (e.g. an acoustical transmitter generates acoustical waves that are in phase with a movement of the acoustical receiver).

Operation 906 depicts providing the energy to a power utilization device via a resonant transmitter and receiver having a Q factor of at least 10,000. For example, as shown in FIG. 1, For example, as shown in FIG. 1, and described above with respect to operations 902 and 904, one or more of the intraluminal generator 100 and the power utilization device 107 may comprise one or more of an acoustical transmitter (e.g. an acoustic transducer and the like) and an acoustical receiver (e.g. a hydrophone) whereby energy may be conveyed via acoustical signals transceived between the intraluminal generator 100 and the power utilization device 107. The one or more acoustical transmitters and acoustical receivers may be in resonance (e.g. an acoustical transmitter generates acoustical waves that are in phase with a movement of the acoustical receiver) where the Q factor of the acoustical transmitter and acoustical receiver is at least 10,000. A transmitter/receiver system may be such as described in “Tunable high-Q surface-acoustic-wave resonator” by Dmitriev, et al., Technical Physics, Volume 52, Number 8, August 2007, pp. 1061-1067(7); U.S. Patent Application Publication No. 20060044078, “Capacitive Vertical Silicon Bulk Acoustic Resonator” to Ayazi, et al.; “Acoustic Wave Generation and Detection in Non-Piezoelectric High-Q Resonators”, Lucklum, et al., Ultrasonics Symposium, 2006, October 2006, Pages: 1132-1135.

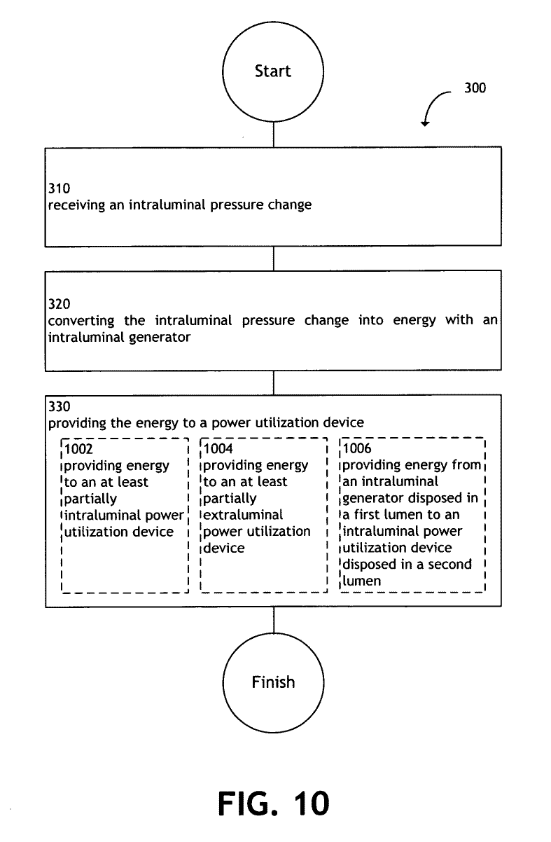

FIGS. 10 and 21 illustrate alternative embodiments of the example operational flow 300 of FIG. 3. FIGS. 10 and 21 illustrate example embodiments where the providing operation 330 may include at least one additional operation. Additional operations may include an operation 1002, an operation 1004 and/or an operation 1006.

Operation 1002 depicts providing energy to an at least partially intraluminal power utilization device. For example, as shown in FIG. 2, energy generated by the intraluminal generator 100 in response to the movement and/or deformation of the pressure change receiving structure 103 may be transmitted to an at least partially intraluminal (e.g. inside of lumen 101A) power utilization device 107A via a coupling 106.

Operation 1004 depicts providing energy to an at least partially extraluminal power utilization device. For example, as shown in FIG. 2, energy generated by the intraluminal generator 100 in response to the movement and/or deformation of the pressure change receiving structure 103 may be transmitted to an at least partially extraluminal (e.g. external to a lumen 101A containing the intraluminal generator 100) power utilization device 107D via a coupling 108.

Operation 1004 depicts providing energy from an intraluminal generator disposed in a first lumen to an intraluminal power utilization device disposed in a second lumen. For example, as shown in FIG. 2, energy generated by the intraluminal generator 100 in response to the movement and/or deformation of the pressure change receiving structure 103 may be transmitted to a power utilization device 107B via a coupling 108. The power utilization device 107B may be located within another lumen (e.g. a lumen 101B which does not contain the intraluminal generator 100). For example, an intraluminal generator 100 disposed within a respiratory lumen 101A may provide energy to a power utilization device 107B disposed within a vascular lumen 101B.

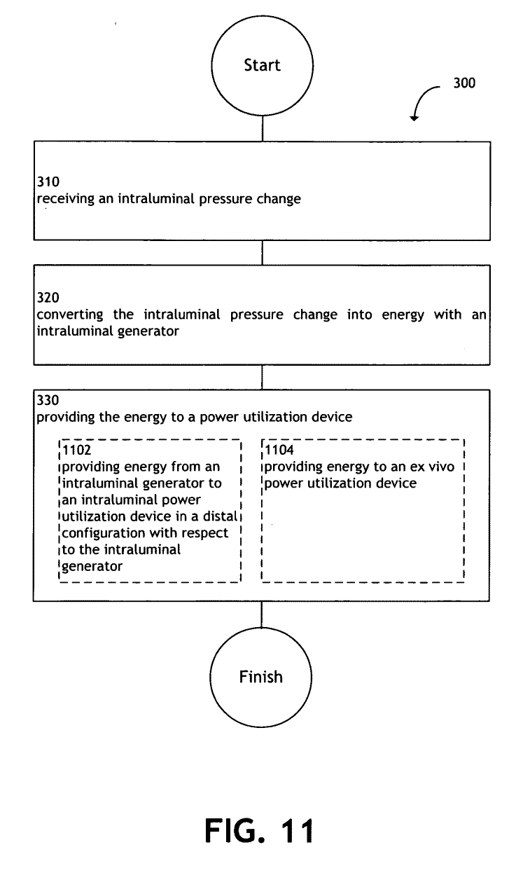

FIGS. 11 and 21 illustrate alternative embodiments of the example operational flow 300 of FIG. 3. FIGS. 11 and 21 illustrate example embodiments where the providing operation 330 may include at least one additional operation. Additional operations may include an operation 1102 and/or an operation 1104.

Operation 1102 depicts providing energy from an intraluminal generator to an intraluminal power utilization device in a distal configuration with respect to the intraluminal generator. For example, as shown in FIG. 2, energy generated by the intraluminal generator 100 in response to the movement and/or deformation of the pressure change receiving structure 103 may be transmitted to a power utilization device 107A in a distal position with respect to the intraluminal generator 100 via a coupling 108. An intraluminal generator 100 disposed within an aorta may provide energy to a power utilization device 107A disposed within a distal vein.

Operation 1104 depicts providing energy to an ex vivo power utilization device. For example, as shown in FIG. 2, energy generated by the intraluminal generator 100 in response to the movement and/or deformation of the pressure change receiving structure 103 may be transmitted to a power utilization device 107C in an ex vivo position (e.g. outside of a body defined by an epidermal layer 110) such as an ex vivo blood glucose monitor.

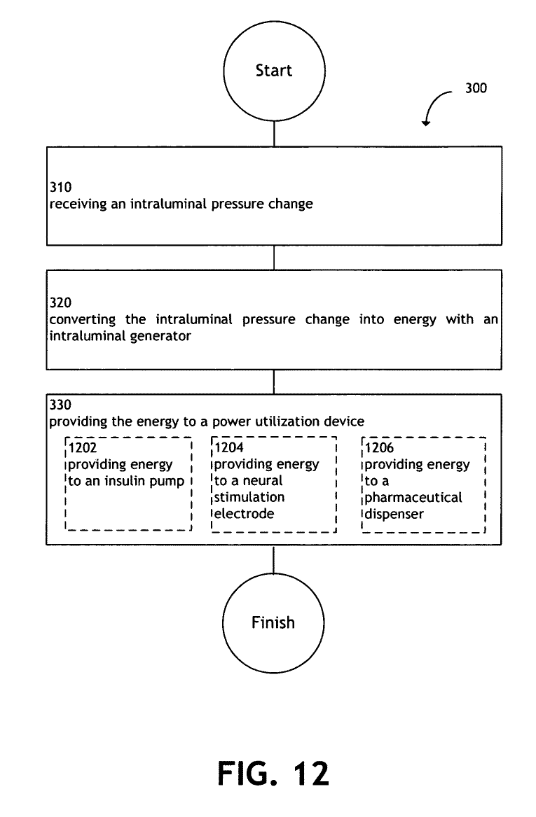

FIGS. 12 and 21 illustrate alternative embodiments of the example operational flow 300 of FIG. 3. FIGS. 12 and 21 illustrate example embodiments where the providing operation 330 may include at least one additional operation. Additional operations may include an operation 1202, an operation 1204 and/or an operation 1206.

Operation 1202 depicts providing energy to an insulin pump. For example, as shown in FIG. 1, energy generated by the intraluminal generator 100 in response to the movement and/or deformation of the pressure change receiving structure 103 may be transmitted to a power utilization device 107 including an insulin pump (e.g. U.S. Pat. No. 5,062,841 “Implantable, self-regulating mechanochemical insulin pump” to Siegel).

Operation 1204 depicts providing energy to a neural stimulation electrode. For example, as shown in FIG. 1, energy generated by the intraluminal generator 100 in response to the movement and/or deformation of the pressure change receiving structure 103 may be transmitted to a power utilization device 107 including an neural stimulation electrode (e.g. U.S. Pat. No. 7,403,821, “Method and implantable systems for neural sensing and nerve stimulation” to Haugland et al.)

Operation 1206 depicts providing energy to a pharmaceutical dispenser. For example, as shown in FIG. 1, energy generated by the intraluminal generator 100 in response to the movement and/or deformation of the pressure change receiving structure 103 may be transmitted to a power utilization device 107 including an pharmaceutical dispenser (e.g. U.S. Pat. No. 5,366,454, “Implantable medication dispensing device” to Currie, et al.)

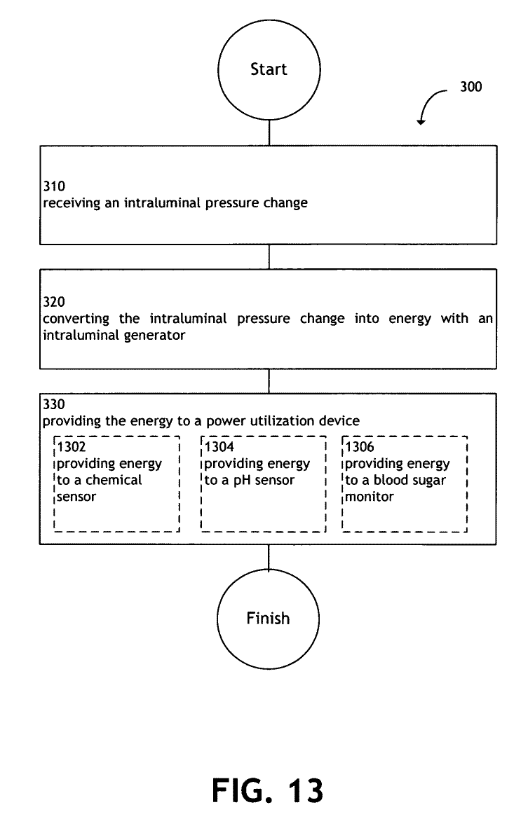

FIGS. 13 and 21 illustrate alternative embodiments of the example operational flow 300 of FIG. 3. FIGS. 13 and 21 illustrate example embodiments where the providing operation 330 may include at least one additional operation. Additional operations may include an operation 1302, an operation 1304 and/or an operation 1306.

Operation 1304 depicts providing energy to a chemical sensor. For example, as shown in FIG. 1, energy generated by the intraluminal generator 100 in response to the movement and/or deformation of the pressure change receiving structure 103 may be transmitted to a power utilization device 107 including a chemical sensor (e.g. U.S. Pat. No. 7,223,237, “Implantable biosensor and methods for monitoring cardiac health” to Shelchuk).

Operation 1306 depicts providing energy to a pH sensor. For example, as shown in FIG. 1, energy generated by the intraluminal generator 100 in response to the movement and/or deformation of the pressure change receiving structure 103 may be transmitted to a power utilization device 107 including a pH sensor (e.g. U.S. Pat. No. 6,802,811, “Sensing, interrogating, storing, telemetering and responding medical implants” to Slepian).

Operation 1308 depicts providing energy to a blood sugar monitor. For example, as shown in FIG. 1, energy generated by the intraluminal generator 100 in response to the movement and/or deformation of the pressure change receiving structure 103 may be transmitted to a power utilization device 107 including an blood sugar monitor (e.g. U.S. Pat. No. 4,538,616, “Blood sugar level sensing and monitoring transducer” to Rogoff.)

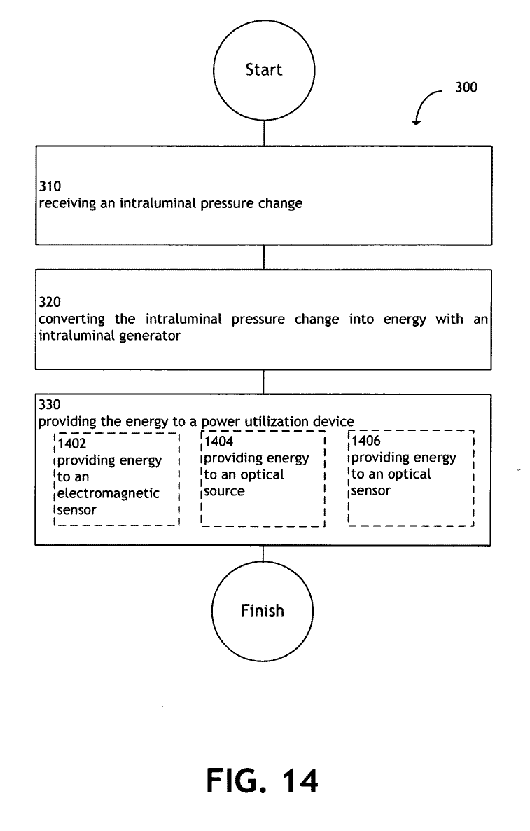

FIGS. 14 and 21 illustrate alternative embodiments of the example operational flow 300 of FIG. 3. FIGS. 14 and 21 illustrate example embodiments where the providing operation 330 may include at least one additional operation. Additional operations may include an operation 1402, an operation 1404 and/or an operation 1406.

Operation 1402 depicts providing energy to an electromagnetic sensor. For example, as shown in FIG. 1, energy generated by the intraluminal generator 100 in response to the movement and/or deformation of the pressure change receiving structure 103 may be transmitted to a power utilization device 107 including an electromagnetic sensor (e.g. U.S. Pat. No. 7,425,200, “Implantable sensor with wireless communication” to Brockway, et al.)

Operation 1404 depicts providing energy to an optical source. For example, as shown in FIG. 1, energy generated by the intraluminal generator 100 in response to the movement and/or deformation of the pressure change receiving structure 103 may be transmitted to a power utilization device 107 including an optical source (e.g. U.S. Pat. No. 7,465,313, “Red light implant for treating degenerative disc disease” to DiMauro, et al.)

Operation 1406 depicts providing energy to an optical sensor. For example, as shown in FIG. 1, energy generated by the intraluminal generator 100 in response to the movement and/or deformation of the pressure change receiving structure 103 may be transmitted to a power utilization device 107 including an optical sensor (e.g. European Patent No. EP1764034, “Implantable self-calibrating optical sensors” to Poore).

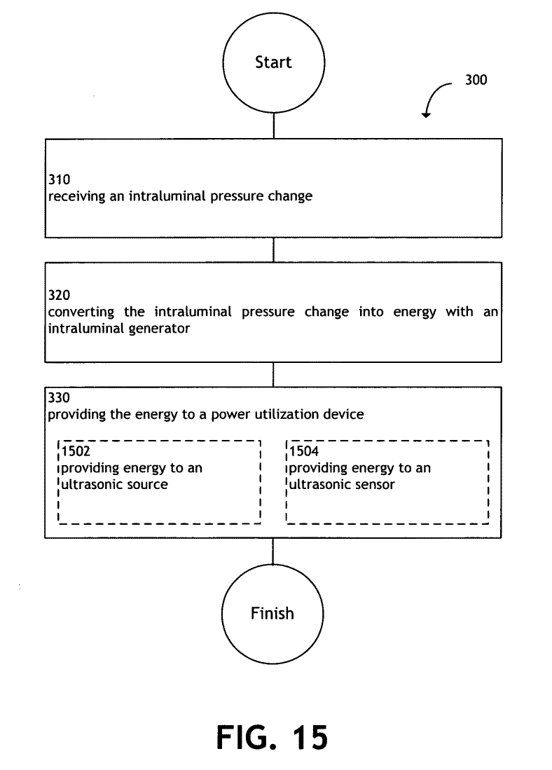

FIGS. 15 and 21 illustrate alternative embodiments of the example operational flow 300 of FIG. 3. FIGS. 15 and 21 illustrate example embodiments where the providing operation 330 may include at least one additional operation. Additional operations may include an operation 1502 and/or an operation 1504.

Operation 1502 depicts providing energy to an ultrasonic source. For example, as shown in FIG. 1, energy generated by the intraluminal generator 100 in response to the movement and/or deformation of the pressure change receiving structure 103 may be transmitted to a power utilization device 107 including an ultrasonic source (e.g. U.S. Patent Application Publication No. 2006/0287598, “System of implantable ultrasonic emitters for preventing restenosis following a stent procedure” to Lasater, et al.)

Operation 1504 depicts providing energy to an ultrasonic sensor. For example, as shown in FIG. 1, energy generated by the intraluminal generator 100 in response to the movement and/or deformation of the pressure change receiving structure 103 may be transmitted to a power utilization device 107 including an ultrasonic sensor (e.g. U.S. Pat. No. 5,967,986, “Endoluminal implant with fluid flow sensing capability” to Cimochowski, et al.)

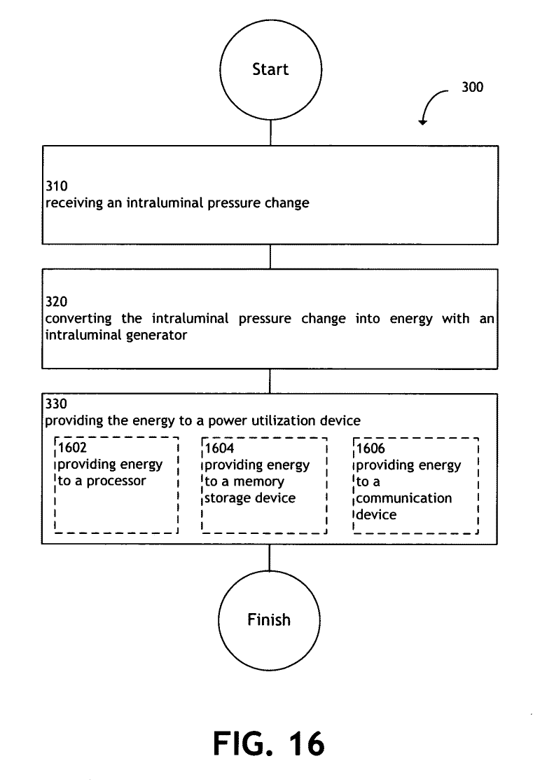

FIGS. 16 and 21 illustrate alternative embodiments of the example operational flow 300 of FIG. 3. FIGS. 16 and 21 illustrate example embodiments where the providing operation 330 may include at least one additional operation. Additional operations may include an operation 1602, an operation 1604 and/or an operation 1606.

Operation 1602 depicts providing energy to a processor. For example, as shown in FIG. 1, energy generated by the intraluminal generator 100 in response to the movement and/or deformation of the pressure change receiving structure 103 may be transmitted to a power utilization device 107 including a processor (e.g. U.S. Pat. No. 5,022,395, “Implantable cardiac device with dual clock control of microprocessor” to Russie).

Operation 1604 depicts providing energy to a memory storage device. For example, as shown in FIG. 1, energy generated by the intraluminal generator 100 in response to the movement and/or deformation of the pressure change receiving structure 103 may be transmitted to a power utilization device 107 including a memory storage device (e.g. U.S. Pat. No. 6,635,048, “Implantable medical pump with multi-layer back-up memory” to Ullestad).

Operation 1606 depicts providing energy to a communication device. For example, as shown in FIG. 1, energy generated by the intraluminal generator 100 in response to the movement and/or deformation of the pressure change receiving structure 103 may be transmitted to a power utilization device 107 including a communication device (e.g. U.S. Pat. No. 7,425,200, “Implantable sensor with wireless communication” to Brockway, et al.)

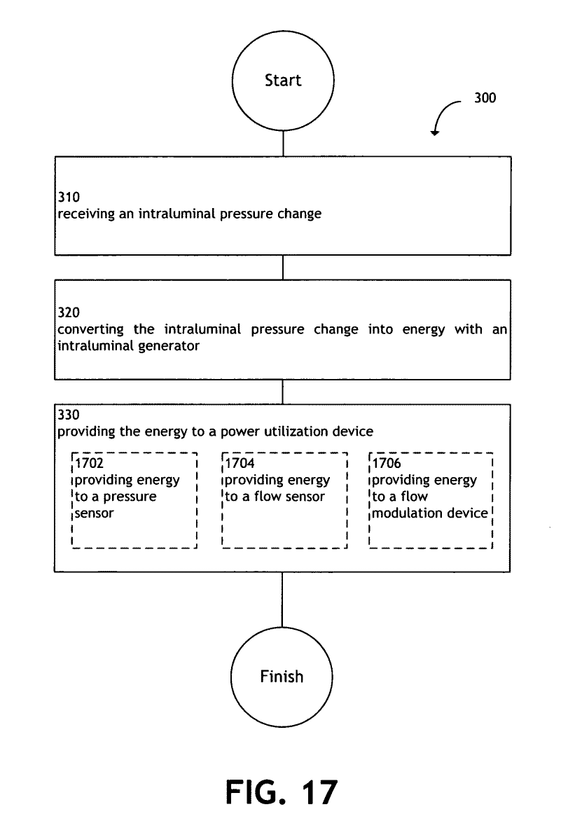

FIGS. 17 and 21 illustrate alternative embodiments of the example operational flow 300 of FIG. 3. FIGS. 17 and 21 illustrate example embodiments where the providing operation 330 may include at least one additional operation. Additional operations may include an operation 1702, an operation 1704 and/or an operation 1706.

Operation 1702 depicts providing energy to a pressure sensor. For example, as shown in FIG. 1, energy generated by the intraluminal generator 100 in response to the movement and/or deformation of the pressure change receiving structure 103 may be transmitted to a power utilization device 107 including an pressure sensor (e.g. U.S. Patent Application Publication No. 2006/0247724, “Implantable optical pressure sensor for sensing urinary sphincter pressure” to Gerber, et al.)

Operation 1704 depicts providing energy to a flow sensor. For example, as shown in FIG. 1, energy generated by the intraluminal generator 100 in response to the movement and/or deformation of the pressure change receiving structure 103 may be transmitted to a power utilization device 107 including a flow sensor (e.g. U.S. Pat. No. 5,522,394, “Implantable measuring probe for measuring the flow velocity of blood in humans and animals” to Zurbrugg).

Operation 1706 depicts providing energy to a flow modulation device. For example, as shown in FIG. 1, energy generated by the intraluminal generator 100 in response to the movement and/or deformation of the pressure change receiving structure 103 may be transmitted to a power utilization device 107 including a flow modulation device (e.g. U.S. Pat. No. 7,367,968, “Implantable pump with adjustable flow rate” to Rosenberg, et al.)

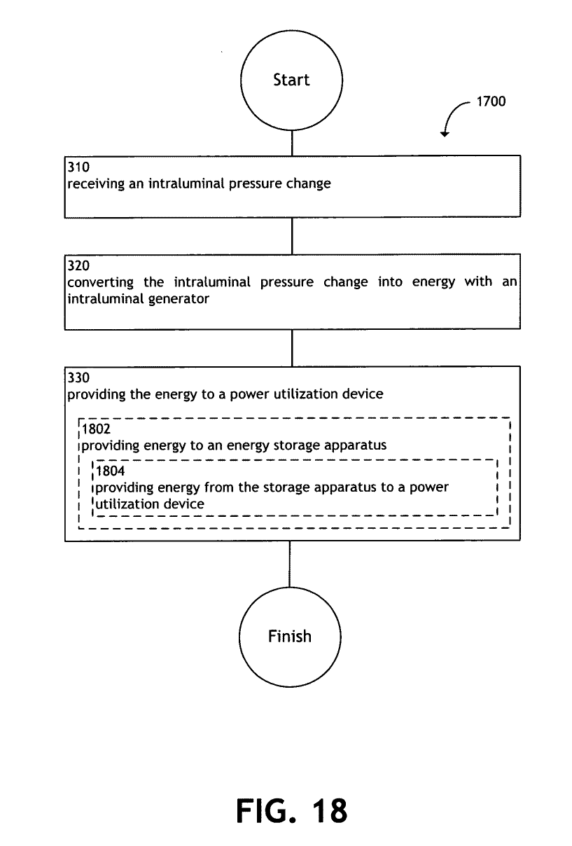

FIGS. 18 and 21 illustrate alternative embodiments of the example operational flow 300 of FIG. 3. FIGS. 18 and 21 illustrate example embodiments where the providing operation 330 may include at least one additional operation. Additional operations may include an operation 1802 and/or an operation 1804.

Operation 1802 depicts providing energy to an energy storage apparatus. For example, as shown in FIG. 1, energy generated by the intraluminal generator 100 in response to the movement and/or deformation of the pressure change receiving structure 103 may be stored in an energy storage apparatus 105. The energy storage apparatus 105 may include, but is not limited to, a capacitive energy storage apparatus, a mechanical energy storage apparatus, a pressure energy storage apparatus, a chemical energy storage apparatus, and the like.

Operation 1804 depicts providing energy from the energy storage apparatus to a power utilization device. For example, as shown in FIG. 1, energy generated by the intraluminal generator 100 in response to the movement and/or deformation of the pressure change receiving structure 103 may be stored in an energy storage apparatus 105. The energy that has been stored in the energy storage apparatus 105 may then be transmitted to a power utilization device 107.

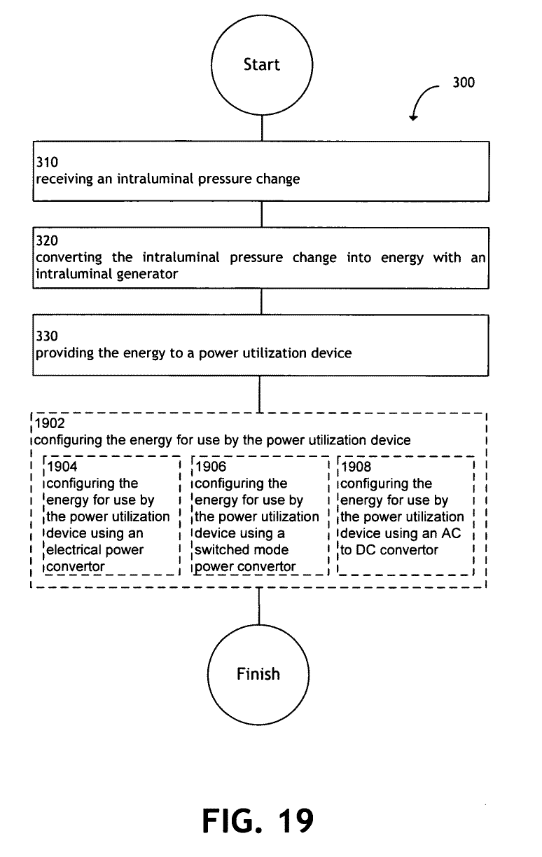

FIGS. 19 and 21 illustrate alternative embodiments of the example operational flow 300 of FIG. 3. FIGS. 19 and 21 illustrate example embodiments where the operational flow 300 may include at least one additional operation. Additional operations may include an operation 1902, an operation 1904, an operation 1906 and/or an operation 1908.

Operation 1902 depicts configuring the energy for use by the power utilization device. For example, as shown in FIG. 1, energy generated by the intraluminal generator 100 in response to the movement and/or deformation of the pressure change receiving structure 103 may be further configured (e.g. rectifying electrical energy, inverting electrical energy, converting energy from a first form (e.g. mechanical energy) to a second form (e.g. electrical energy), and the like) by a power converter 109 for use by a power utilization device 107 (e.g. a sensor, a pump, an electrode, a memory, a communications device, a energy storage apparatus, and the like).

Operation 1904 depicts configuring the energy for use by the power utilization device using an electrical power convertor. For example, as shown in FIG. 1, energy generated by the intraluminal generator 100 in response to the movement and/or deformation of the pressure change receiving structure 103 may be further configured by an electrical power converter 109 (e.g. “Implantable RF Power Converter for Small Animal In Vivo Biological Monitoring” by Chaimanonart, et al.; Proceedings of the 2005 IEEE Engineering in Medicine and Biology 27th Annual Conference; Sep. 1-4, 2005).

Operation 1906 depicts configuring the energy for use by the power utilization device using a switched mode power convertor. For example, as shown in FIG. 1, energy generated by the intraluminal generator 100 in response to the movement and/or deformation of the pressure change receiving structure 103 may be further configured by a switched-mode power converter 109 (e.g. U.S. Pat. No. 6,426,628; “Power management system for an implantable device” to Palm et al.)

Operation 1908 depicts configuring the energy for use by the power utilization device using an AC to DC convertor. For example, as shown in FIG. 1, energy generated by the intraluminal generator 100 in response to the movement and/or deformation of the pressure change receiving structure 103 may be further configured by an AC-to-DC power converter 109 (e.g. U.S. Pat. No. 7,167,756; “Battery recharge management for an implantable medical device” to Torgerson, et al).

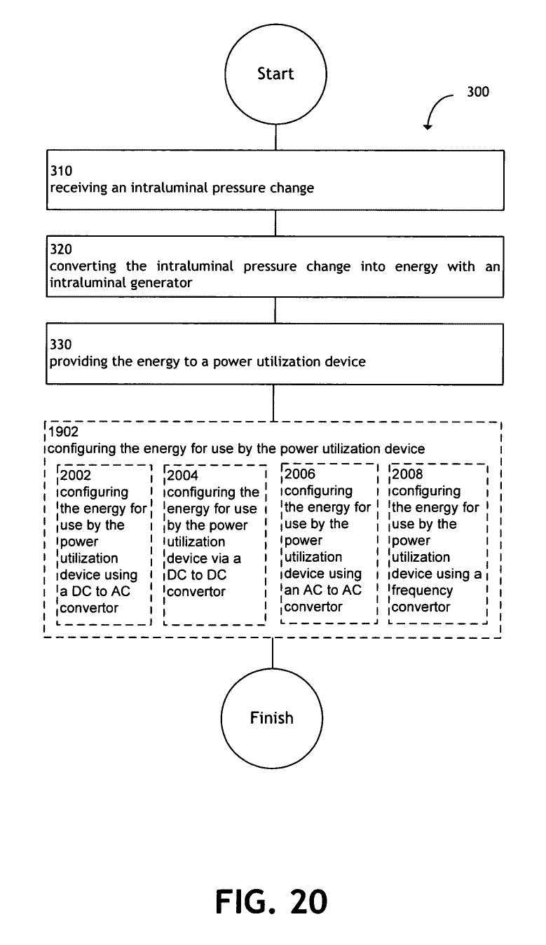

FIGS. 20 and 21 illustrate alternative embodiments of the example operational flow 300 of FIG. 19. FIGS. 20 and 21 illustrate example embodiments where the operation 1902 the operational flow 300 of may include at least one additional operation. Additional operations may include an operation 2002, an operation 2004, an operation 2006, and/or an operation 2008.

Operation 2002 depicts configuring the energy for use by the power utilization device using a DC to AC convertor. For example, as shown in FIG. 1, energy generated by the intraluminal generator 100 in response to the movement and/or deformation of the pressure change receiving structure 103 may be further configured by a DC-to-AC power converter 109 (e.g. U.S. Pat. No. 6,937,894; “Method of recharging battery for an implantable medical device” to Isaac, et al).

Operation 2004 depicts configuring the energy for use by the power utilization device via a DC to DC convertor. For example, as shown in FIG. 1, energy generated by the intraluminal generator 100 in response to the movement and/or deformation of the pressure change receiving structure 103 may be further configured by a DC-to-DC power converter 109 (e.g. U.S. Pat. No. 7,489,966; “Independent therapy programs in an implantable medical device” to Leinders, et al).

Operation 2006 depicts configuring the energy for use by the power utilization device using an AC to AC convertor. For example, as shown in FIG. 1, energy generated by the intraluminal generator 100 in response to the movement and/or deformation of the pressure change receiving structure 103 may be further configured by an AC-to-AC power converter 109 (e.g. U.S. Pat. No. 5,188,738; “Alternating current supplied electrically conductive method and system for treatment of blood and/or other body fluids and/or synthetic fluids with electric forces” by Kaali, et al).

Operation 2006 depicts configuring the energy for use by the power utilization device using a frequency convertor. For example, as shown in FIG. 1, energy generated by the intraluminal generator 100 in response to the movement and/or deformation of the pressure change receiving structure 103 may be further configured by an frequency power converter 109 (e.g. U.S. Pat. No. 6,829,507; “Apparatus for determining the actual status of a piezoelectric sensor in a medical implant” by Lidman, et al).

The herein described subject matter may illustrate different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. The method comprising:
receiving an intraluminal pressure change,
converting an intraluminal pressure change into energy with an intraluminal generator; and
providing the energy to a power utilization device.

2. The method of claim 1, wherein the providing the energy to a power utilization device comprises:
providing the energy to a power utilization device via an electrical coupling.

3. The method of claim 1, wherein the providing the energy to a power utilization device comprises:
providing the energy to a power utilization device via radiant transmission.

4. The method of claim 1, wherein the providing the energy to a power utilization device comprises:
providing the energy to a power utilization device via an electromagnetic radiation coupling.

5. The method of claim 4, wherein the providing the energy to a power utilization device via an electromagnetic radiation coupling comprises:
providing the energy to a power utilization device via an optical coupling.

6. The method of claim 5, wherein the providing the energy to a power utilization device via an optical coupling comprises:
providing the energy to a power utilization device via an optical fiber.

7. The method of claim 5, wherein the providing the energy to a power utilization device via an optical coupling comprises:
providing the energy to a power utilization device via a direct photo-conversion optical coupling.

8. The method of claim 4, wherein the providing the energy to a power utilization device via an electromagnetic radiation coupling comprises:
providing the energy to a power utilization device via a radio frequency coupling.

9. The method of claim 8, wherein the providing the energy to a power utilization device via a radio frequency coupling comprises:
providing the energy to a power utilization device via a radio frequency coupling employing a device-specific frequency.

10. The method of claim 8, wherein the providing the energy to a power utilization device via a radio frequency coupling comprises:
providing the energy to a power utilization device via a radio frequency coupling employing a user-specific frequency.

11. The method of claim 4, wherein the providing the energy to a power utilization device via an electromagnetic radiation coupling comprises:
providing the energy to a power utilization device via an infrared coupling.

12. The method of claim 1, wherein the providing the energy to a power utilization device comprises:
providing the energy to a power utilization device via an inductive coupling.

13. The method of claim 12, wherein the providing the energy to a power utilization device via an inductive coupling comprises:
providing the energy to a power utilization device via a resonant inductive coupling.

14. The method of claim 12, wherein the providing the energy to a power utilization device via an inductive coupling comprises:
providing the energy to a power utilization device via a first resonant inductive coupling in resonance with a second resonant inductive coupling.

15. The method of claim 1, wherein the providing the energy to a power utilization device via radiant transmission comprises:
providing the energy to a power utilization device via an acoustical coupling.

16. The method of claim 15, wherein the providing the energy to a power utilization device via an acoustical coupling comprises:
providing the energy to a power utilization device via a resonant transmitter and receiver.

17. The method of claim 16, wherein the providing the energy to a power utilization device via a resonant transmitter and receiver comprises:
providing the energy to a power utilization device via a resonant transmitter and receiver having a Q factor of at least 10,000.

18. The method of claim 1, wherein the providing the energy to a power utilization device comprises:
providing energy to an at least partially intraluminal power utilization device.

19. The method of claim 1, wherein the providing the energy to a power utilization device comprises:
providing energy to an at least partially extraluminal power utilization device.

20. The method of claim 1, wherein the providing the energy to a power utilization device comprises:
providing energy from an intraluminal generator disposed in a first lumen to an intraluminal power utilization device disposed in a second lumen.

21. The method of claim 1, wherein the providing the energy to a power utilization device comprises:
providing energy from an intraluminal generator to an intraluminal power utilization device in a distal configuration with respect to the intraluminal generator.

22. The method of claim 1, wherein the providing the energy to a power utilization device comprises:
providing energy to an ex vivo power utilization device.

23. The method of claim 1, wherein the providing the energy to a power utilization device comprises:
providing energy to an insulin pump.

24. The method of claim 1, wherein the providing the energy to a power utilization device comprises:
providing energy to a neural stimulation electrode.

25. The method of claim 1, wherein the providing the energy to a power utilization device comprises:
providing energy to a pharmaceutical dispenser.

26. The method of claim 1, wherein the providing the energy to a power utilization device comprises:
providing energy to a chemical sensor.

27. The method of claim 1, wherein the providing the energy to a power utilization device further comprises:
providing energy to a pH sensor.

28. The method of claim 1, wherein the providing the energy to a power utilization device comprises:
providing energy to a blood sugar monitor.

29. The method of claim 1, wherein the providing the energy to a power utilization device comprises:
providing energy to an electromagnetic sensor.

30. The method of claim 1, wherein the providing the energy to a power utilization device comprises:
providing energy to an optical source.

31. The method of claim 1, wherein the providing the energy to a power utilization device comprises:
providing energy to an optical sensor.

32. The method of claim 1, wherein the providing the energy to a power utilization device comprises:
providing energy to an ultrasonic source.

33. The method of claim 1, wherein the providing energy to an at least partially intraluminal power utilization device comprises:
providing energy to an ultrasonic sensor.

34. The method of claim 1, wherein the providing the energy to a power utilization device comprises:
providing energy to a processor.

35. The method of claim 1, wherein the providing the energy to a power utilization device comprises:
providing energy to a memory storage device.

36. The method of claim 1, wherein the providing the energy to a power utilization device comprises:
providing energy to a communication device.

37. The method of claim 1, wherein the providing the energy to a power utilization device further comprises:
providing energy to a pressure sensor.

38. The method of claim 1, wherein the providing the energy to a power utilization device further comprises:
providing energy to a flow sensor.

39. The method of claim 1, wherein the providing the energy to a power utilization device further comprises:
providing energy to a flow modulation device.

40. The method of claim 1, wherein the providing the energy to a power utilization device comprises:
providing energy to an energy storage apparatus

41. The method of claim 40, further comprising:
providing energy from the energy storage apparatus to a power utilization device.

42. The method of claim 1, further comprising:
configuring the energy for use by the power utilization device.

43. The method of claim 42, wherein the configuring the energy for use by the power utilization device comprises:
configuring the energy for use by the power utilization device using an electrical power convertor.

44. The method of claim 42, wherein the configuring the energy for use by the power utilization device comprises:
configuring the energy for use by the power utilization device using a switched mode power convertor.

45. The method of claim 42, wherein the configuring the energy for use by the power utilization device comprises:
configuring the energy for use by the power utilization device using an AC to DC convertor.

46. The method of claim 42, wherein the configuring the energy for use by the power utilization device comprises:
configuring the energy for use by the power utilization device using a DC to AC convertor.

47. The method of claim 42, wherein the configuring the energy for use by the power utilization device comprises:
configuring the energy for use by the power utilization device via a DC to DC convertor.

48. The method of claim 42, wherein the configuring the energy for use by the power utilization device comprises:
configuring the energy for use by the power utilization device using an AC to AC convertor.

49. The method of claim 42, wherein the configuring the energy for use by the power utilization device comprises:
configuring the energy for use by the power utilization device using a frequency convertor.
